(19) United States
(12) Patent Application Publication
(10) Pub. No.: US 2005/0097446 A1
(43) Pub. Date: May 5, 2005

(54) Drawing management system

(75) Inventors: Norikazu Fuchino, Kanagawa-ken (JP); Fumihiko Nagashima, Fujinomiya-shi (JP); Yoshifumi Waki, Fujinomiya-shi (JP); Akio Ishikawa, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/973,241

(22) Filed: Oct. 27, 2004

(30) Foreign Application Priority Data
Oct. 30, 2003 (JP) 2003-369759

(51) Int. Cl. G06F 17/00; G06F 17/24

(52) U.S. Cl. 715/502; 715/530

(57) ABSTRACT

A drawing information editing device controls a drawing registering device to read a drawing with a scanner, and stores actual drawing image data and compressed drawing image data, together with drawing attribute data, in a data storage device of a drawing information storing device. A drawing retrieving device retrieves compressed drawing image data according to a set retrieval condition based on drawing attribute data, displays a compressed drawing based on the compressed drawing image data, and displays a desired drawing selected from the compressed drawing based on actual drawing image data.

### BACKGROUND OF THE INVENTION

1. Field of the Invention

The present invention relates to a drawing management system for registering drawings, retrieving drawings based on retrieval conditions, and outputting retrieved drawings.

2. Description of the Related Art

There has heretofore been developed a system for reading a number of design drawings or the like with a scanner, storing them in a memory device, specifying retrieval conditions when necessary, and retrieving and displaying a desired drawing.

If drawings have a large size or drawings contain a large amount of information, then a long processing time is required in order to retrieve and display a desired drawing. Therefore, there is currently a limitation on the number of drawings that can be retrieved once.

According to the conventional system disclosed in Japanese laid-open patent publication No. 6-44330, drawing data are stored in a drawing memory device, and profile data such as of straight lines, circles, characters, etc. of the drawing data are stored in a display drawing memory device. When a drawing retrieval instruction is entered, drawing data corresponding to the drawing retrieval instruction is retrieved from the drawing memory device, and profile data corresponding to the retrieved drawing data is read from the display drawing memory device. An image is constructed from the profile data and then displayed. The conventional system is arranged to shorten a period of time required to display the image.

Though the conventional system disclosed in Japanese laid-open patent publication No. 6-44330 can shorten the period of time required to display the image, it still needs a long processing time for retrieving drawing data because a large amount of drawing data has to be searched prior to the display of the image. If the displayed image is not a desired image, then the process of retrieving drawing data and constructing and displaying an image based on the corresponding profile data needs to be repeated, resulting in a long period of time required to retrieve desired drawing data.

### SUMMARY OF THE INVENTION

It is a general object of the present invention to provide a drawing management system which is capable of registering and storing a number of drawings and of efficiently retrieving and outputting a desired drawing under retrieval conditions.

Another object of the present invention is to provide a drawing management system which can avoid the creation of a wasteful space for the storage of drawings.

Still another object of the present invention is to provide a drawing management system which is able to accurately and efficiently performing an editing process when registering drawings.

Yet another object of the present invention is to provide a drawing management system which is capable of efficiently modifying or eliminating facilities based on the information of a related facility drawing.

Still yet another object of the present invention is to provide a drawing management system which makes it possible to narrow a large number of drawings to a desired drawing for retrieval.

A further object of the present invention is to provide a drawing management system which is capable of efficiently managing related drawings.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a drawing management system according to an embodiment of the present invention;

FIG. 2 is a functional block diagram of major devices of the drawing management system according to the embodiment;

FIG. 3 is a flowchart of a drawing reserving process, a drawing registering process, and a drawing saving process;

FIG. 4 is a flowchart of a drawing retrieving process;

FIG. 5 is a view showing a menu image displayed on a display monitor of a drawing retrieving device;

FIG. 6 is a view showing a drawing number retrieving image displayed on the display monitor of the drawing retrieving device;

FIG. 7 is a diagram showing a rule for entering a drawing number;

FIG. 8 is a view showing a drawing attribute data registering image displayed on the display monitor of the drawing retrieving device;

FIG. 9 is a view showing a new registration image displayed on the display monitor of the drawing retrieving device;

FIG. 10 is a diagram showing a rule for entering a drawing title;

FIG. 11 is a view showing a revision registration image displayed on the display monitor of the drawing retrieving device;

FIG. 12 is a view showing a registration request slip generated by the drawing retrieving device;

FIG. 13 is a view showing a drawing;

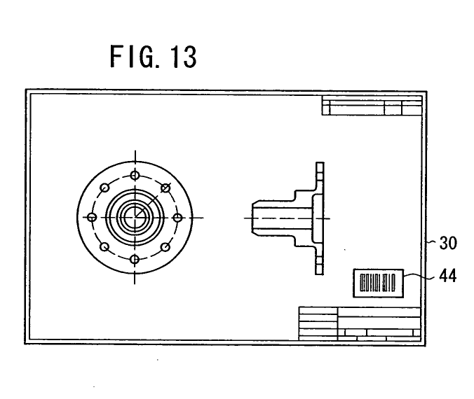

FIG. 14 is a view showing a bundle of drawing sheets;

FIG. 15 is a view showing a retrieval condition input image displayed on the display monitor of the drawing retrieving device;

FIG. 16 is a view showing a drawing retrieval result image displayed on the display monitor of the drawing retrieving device;

FIG. 17 is a view showing a drawing retrieval result image comprising a compressed image displayed on the display monitor of the drawing retrieving device;

FIG. 18 is a diagram showing the manner in which the compressed image shown in FIG. 17 is scrolled;

FIG. 19 is a view showing a drawing retrieval result image comprising an actual drawing displayed on the display monitor of the drawing retrieving device;

FIG. 20 is a view showing a retrieval condition input image displayed on the display monitor of the drawing retrieving device; and

FIG. 21 is a view showing a completion report list image displayed on the display monitor of the drawing retrieving device.

### DESCRIPTION OF THE PREFERRED EMBODIMENT

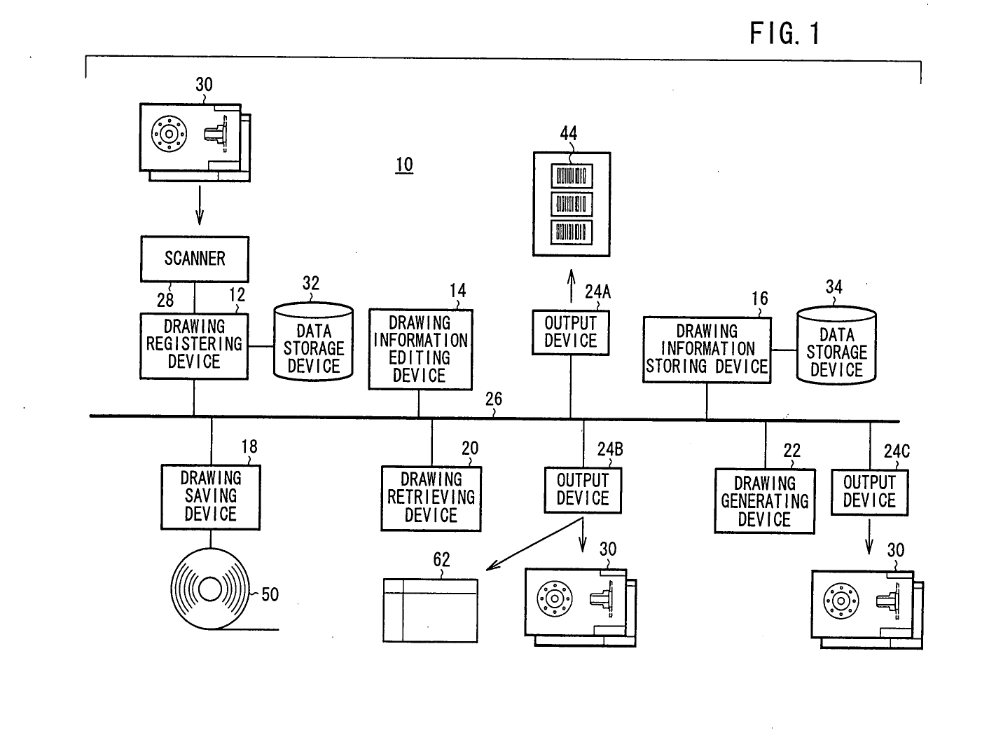

FIG. 1 shows in block form a drawing management system 10 according to an embodiment of the present invention. As shown in FIG. 1, the drawing management system 10 comprises a drawing registering device 12, a drawing information editing device 14, a drawing information storing device 16, a drawing saving device 18, a drawing retrieving device 20, a drawing generating device 22, and output devices 24A through 24C which are all connected to each other by a network 26.

The drawing registering device 12 reads a drawing 30 with a scanner 28 connected thereto, and registers the read data as actual drawing image data Dorg, which is not subjected to a compression process such as an image coding process or the like, in a data storage device 32. The data storage device 32 registers therein the actual drawing image data Dorg and also drawing attribute data Datt edited by the drawing information editing device 14 in association with the actual drawing image data Dorg.

The drawing 30 includes not only a paper drawing of a machine, a facility, a circuit, or the like, but also a document image of every type of paper document such as an inspection document, a calculation document, an estimation document, or the like about a facility construction. The drawing attribute data Datt, which will be described in detail below, data representative of an ID number and a drawing title of the drawing 30, department information as to a department, a line, etc. corresponding to the drawing 30, a generation date of the drawing 30, the name of a person in charge of the drawing 30, etc.

The drawing information editing device 14 controls the drawing registering device 12 to register and edit the drawing 30, and also controls the drawing information storing device 16 to store various data including the actual drawing image data Dorg and the drawing attribute data Datt in a data storage device 34 connected to the drawing information storing device 16.

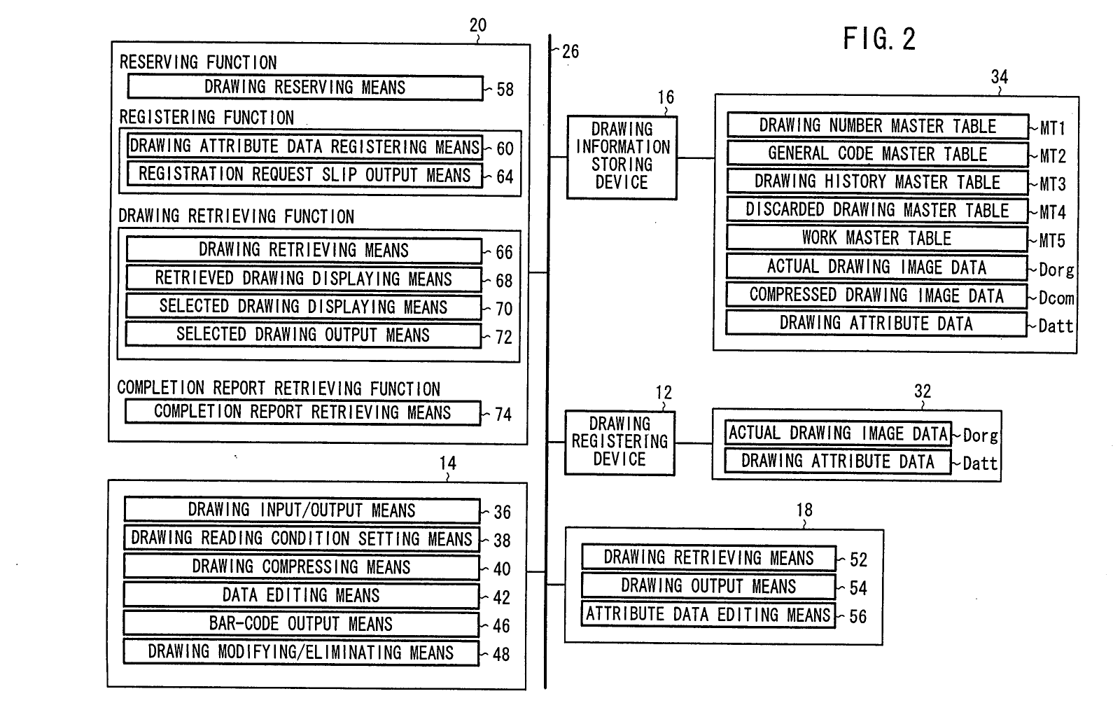

As shown in FIG. 2, the drawing information editing device 14 comprises a drawing input/output means 36 for inputting and outputting the actual drawing image data Dorg and the drawing attribute data Datt into and from the data storage device 32 that is connected to the drawing registering device 12, a drawing reading condition setting means 38 for setting general drawing reading conditions of the scanner 28 such as a resolution, a reading size, a reading direction, etc. for reading a drawing 30, a drawing compressing means 40 for compressing, e.g., image-coding, the actual drawing image data Dorg of the read drawing 30, to generate compressed drawing image data Dcom, a data editing means 42 for editing various data, a bar-code output means 46 for printing a bar code 44 (see FIG. 1) with an ID number identifying each drawing 30 with the output device 24A, and a drawing modifying/eliminating means 48 for modifying and eliminating drawings 30 that have already been registered.

Data that are to be edited by the data editing means 42 include actual drawing image data Dorg, compressed drawing image data Dcom, drawing attribute data Datt, a drawing number master table MT1, a general code master table MT2, a drawing history master table MT3, a discarded drawing master table MT4, and a work master table MT5. These data are stored in the data storage device 34 that is connected to the drawing information storing device 16.

The drawing number master table MT1 is a management table for setting drawing numbers for drawings 30 without overlaps, and stores drawing reservation data including drawing numbers prior to the registration of drawings. The general code master table MT2 is a management table for keywords that are used to set and retrieve drawing attribute data Datt, and stores, as keywords, the type of a drawing 30 to be registered, the name of a person in charge of the drawing 30, and the information of a department corresponding to the drawing 30. The drawing history master table MT3 stores information of old drawings 30 that are produced as a result of the revision of drawings 30. The discarded drawing master table MT4 stores information of discarded drawing 30. The work master table MT5 stores information of works that have used drawings 30.

The drawing saving device 18 saves an image of a drawing 30 on a microfilm 50 (external storage medium) through a CD-ROM or the like. The drawing saving device 18 has a drawing retrieving means 52 for retrieving a drawing 30 that has not been saved on the microfilm 50 based on a microfilm (MF) storage flag which is one of the drawing attribute data Datt, a drawing output means 54 for outputting the retrieved drawing 30 relative to the drawing attribute data Datt to a CD-ROM or the like based on actual drawing image data Dorg, and an attribute data editing means 56 for setting the MF storage flag of the drawing attribute data Datt relative to the drawing 30 when the drawing 30 is recorded on the microfilm 50 through a CD-ROM or the like.

The drawing retrieving device 20 is a computer assigned to each operator who is desirous of registering drawings 30. The drawing retrieving device 20 has a reserving function for reserving the registration of a drawing 30, a registering function for registering drawing attribute data Datt based on drawing reservation data and generating a registration request slip, a drawing retrieving function for retrieving a desired drawing 30, and a completion report retrieving function for retrieving a completion report which is a work report that comprises a plurality of registered drawings 30.

The reserving function has a drawing reserving means 58 for reserving in advance the drawing number of a drawing 30 to be registered without overlaps, using the drawing number master table MT1 stored in the data storage device 34.

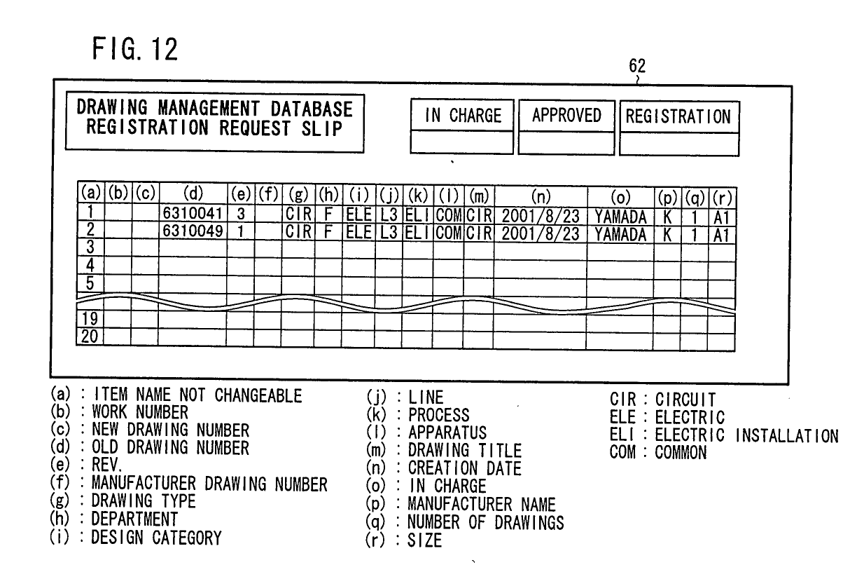

The registering function has a drawing attribute data registering means 60 for registering drawing attribute data Datt of the drawing 30 for a drawing number registered by the drawing reserving means 58, and a registration request slip output means 64 for outputting a registration request slip 62 (see FIG. 12) from the output device 24B based on the registered drawing attribute data Datt. The registration request slip 62 is provided, together with the drawing 30 to be registered, to the operator of the drawing information editing device 14 to ask for a registering process.

The drawing retrieving function has a drawing retrieving means 66 for setting a desired drawing retrieving condition and retrieving a drawing 30 having drawing attribute data Datt that matches the drawing retrieving condition, a retrieved drawing displaying means 68 for generating the retrieved drawing 30 from compressed drawing image data Dcom and displaying the drawing 30 together with the drawing attribute data Datt, a selected drawing displaying means 70 for displaying the compressed drawing 30 displayed by the retrieved drawing displaying means 68 as an uncompressed drawing 30 using actual drawing image data Dorg, and a selected drawing output means 72 for outputting the drawing 30 displayed by the selected drawing displaying means 70 from the output device 24B.

The completion report retrieving function has a completion report retrieving means 74 for setting a desired work retrieval condition and retrieving a completion report having drawing attribute data Datt that matches the work retrieval condition. The retrieved completion report may be output from the output device 24B.

The drawing generating device 22 comprises a CAD (Computer-Aided Design) device. A drawing 30 output from the output device 24C can be registered by the drawing registering device 12, and its drawing attribute data Datt can be registered by the drawing retrieving device 20. The drawing generating device 22 may have the same functions as those of the drawing retrieving device 20 to make it possible to register and retrieve a desired drawing 30.

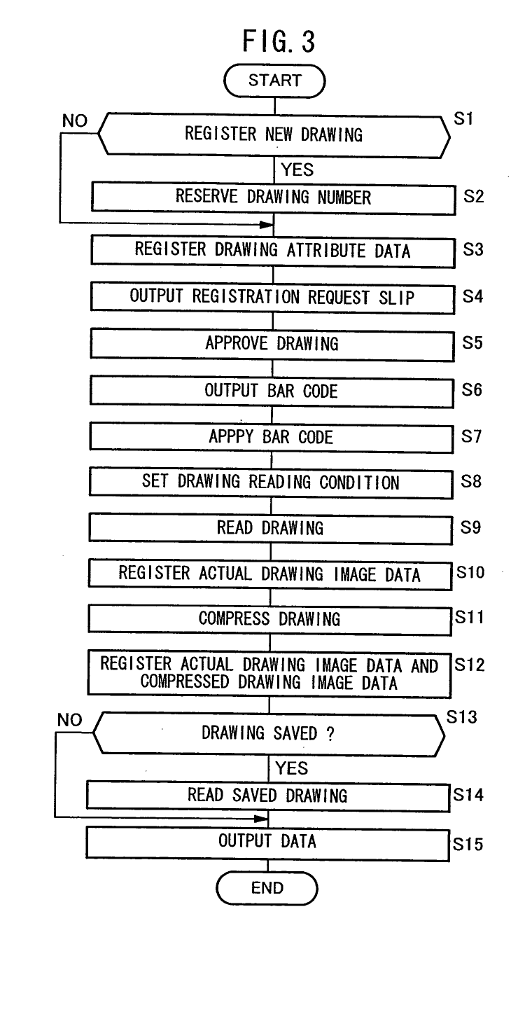

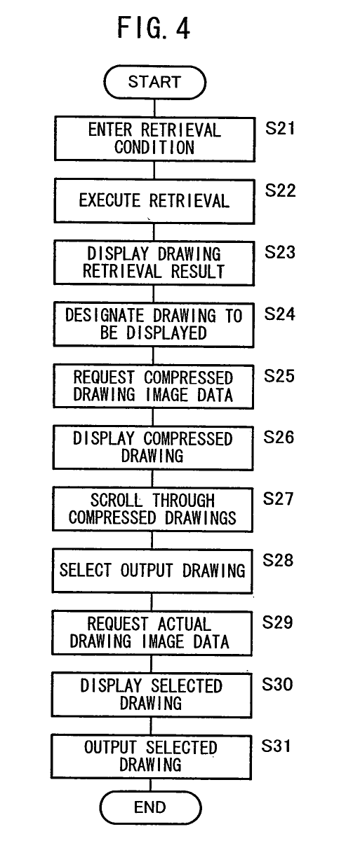

The drawing management system 10 according to the present embodiment is basically constructed as described above. Processes of registering, saving and retrieving a drawing 30 using the drawing management system 10 will be described below with reference to FIGS. 3 and 4.

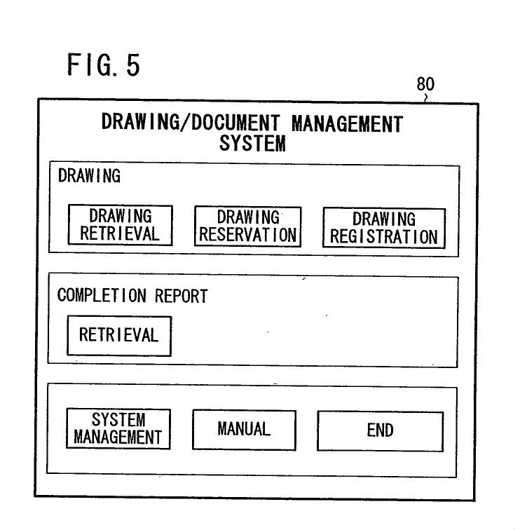

When the drawing management system 10 is activated, the display monitor of each operator displays a menu image 80 shown in FIG. 5.

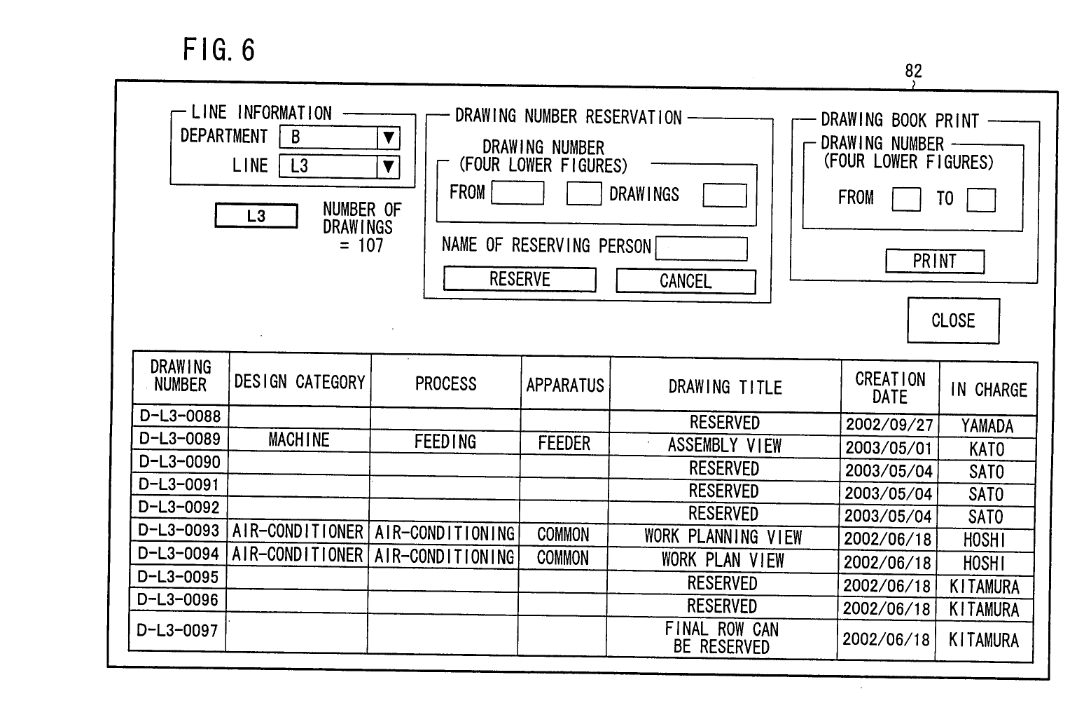

For registering a new drawing 30 in step S1, the operator selects a “DRAWING RESERVATION” button in the menu image 80. When the “DRAWING RESERVATION” button is selected, a drawing number reservation image 82 shown in FIG. 6 is displayed on the display monitor. The operator reserves the drawing number using the drawing number reservation image 82 in step S2.

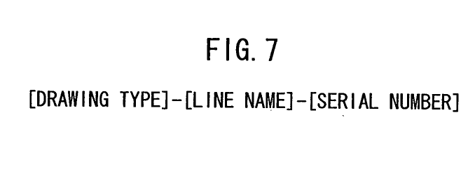

As shown in FIG. 7, the drawing number comprises “DRAWING TYPE” in the form of an alphabetical letter representing the type of the drawing 30 to be registered, “LINE NAME” in the form of an alphabetical letter representing the name of a facility relative to the drawing 30, and “SERIAL NUMBER” in the form of four successive numerals without overlaps. For Example, “DRAWING TYPE” D indicates a design drawing of a facility, “DRAWING TYPE” R indicates a document drawing comprising a document image of an inspection document, a calculation document, an estimation document, or the like, and “LINE NAME” L3 indicates a third production line in a corresponding department. These classifications are preset in the general code master table MT2 of the data storage device 34.

When the operator enters information of the department involving the facility and the production line relative to the drawing 30 based on the information set in the general code master table MT2, the drawing reserving means 58 displays reserved information of drawing numbers in the department B and the line L3, for example, using the drawing number master table MT1 and the drawing attribute data Datt that are stored in the data storage device 34.

A drawing number D-L3-0088, for example, that has already been reserved by another operator is displayed as “RESERVED” in the column of drawing titles. Therefore, the operator cannot use this drawing number. Another drawing number D-L3-0089, for example, is also a drawing number whose drawing 30 has already been registered because various items information including a design category, a process, an apparatus, a drawing title, a creation data, and a person in charge are displayed in corresponding columns. Therefore, the operator selects a drawing number other than those registered drawing numbers.

The operator sets as many “serial numbers” of drawing numbers that can be reserved as necessary, enters the name of the reserving person, and selects a “RESERVE” button, thus completing the process of reserving the drawing number. If the drawing 30 has already been registered and the operator is to edit the drawing 30, then the process of reserving the drawing number is not performed.

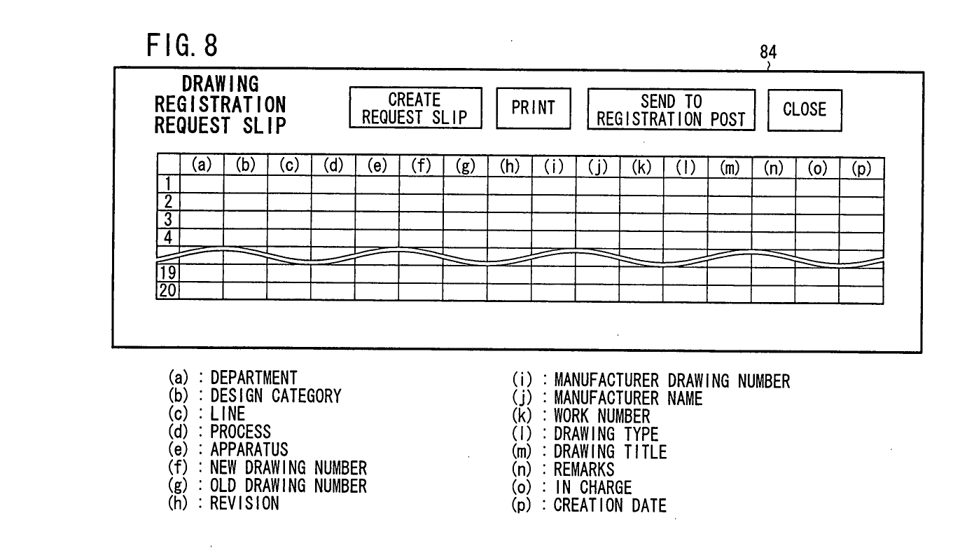

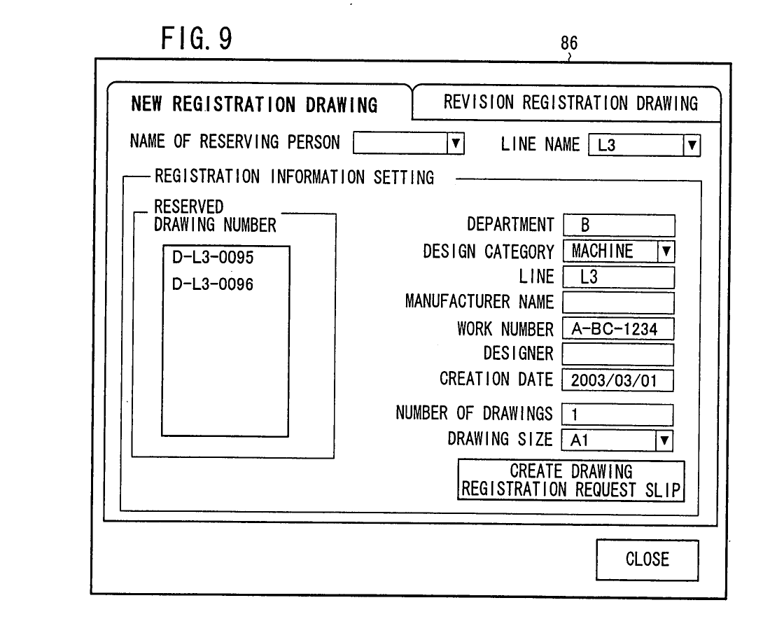

When the operator selects a “DRAWING REGISTRATION” button in the menu image 80, the drawing attribute data registering means 60 displays a drawing attribute data registration image 84 shown in FIG. 8 on the display monitor, allowing the operator to perform a registration process in step S3. When the operator selects a “CREATE REQUEST SLIP” button in the drawing attribute data registration image 84, a new registration image 86 for registering a new drawing 30 shown in FIG. 9 is displayed on the display monitor. When the operator enters the name of the reserving person and the line abbreviation in the new registration image 86, if the reservation process is performed in step S2, the list of drawing numbers reserved in the drawing number reservation image 82 by the reserving person is displayed as indicating reserved drawing numbers.

The operator enters drawing attribute data Datt including the design category, the name of the manufacturer who produced the drawing 30, the work number of the drawing 30, the designer, the creation date, the number of sheets of the drawing 30, and the drawing size, using the new registration image 86. The operator selects, if necessary, a plurality of drawing numbers which share the entered drawing attribute data Datt. When the operator selects a “CREATE DRAWING REGISTRATION REQUEST SLIP” button in the new registration image 86, the drawing attribute data registration image 84 shown in FIG. 8 which reflects the drawing attribute data Datt entered in the new registration image 86 is displayed. The operator then enters any further necessary drawing attribute data Datt in the displayed drawing attribute data registration image 84.

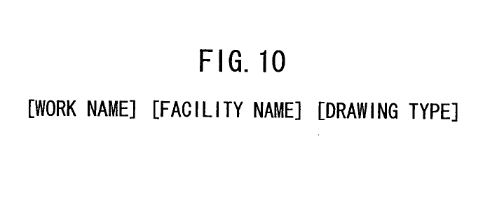

At this time, the operator enters the drawing attribute data Datt by selecting keywords registered in the general code master table MT2 of the data storage device 34. Therefore, drawing attribute data Datt are prevented from being entered in different formats by different operators. With regard to drawing titles that are difficult to register as keywords, a data entering rule for entering dada in the order of “WORK NAME”, “FACILITIY NAME”, “DRAWING TYPE” as shown in FIG. 10 is employed to allow drawing attribute data Datt to be entered in a generalized format.

By thus entering common drawing attribute data Datt using the new registration image 86, the operator can enter drawing attribute data Datt efficiently while eliminating any overlapping entering actions.

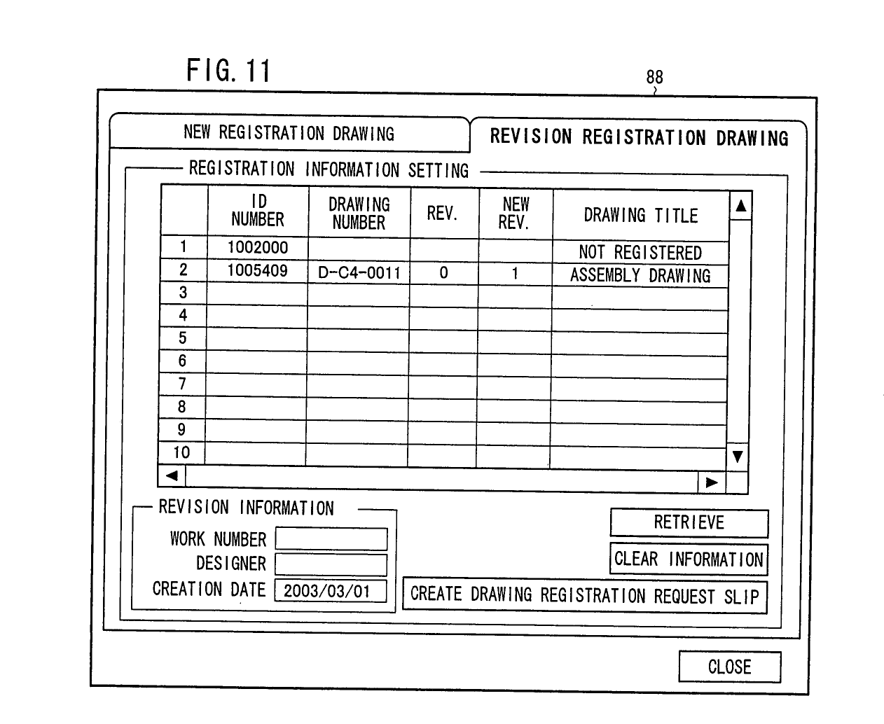

If the operator does not perform drawing number reserving process in step S2, but is to revise an already registered drawing 30, then the operator selects a revision registration drawing tag in the new registration image 86 shown in FIG. 9 to display a revision registration image 88 shown in FIG. 11. Then, the operator enters the ID number or drawing number of the drawing 30 to be revised, and selects a “RETRIEVE” button. The drawing attribute data registering means 60 retrieves corresponding drawing attribute data Datt from the data storage device 34, and displays the retrieved drawing attribute data Datt in the revision registration image 88. The operator enters revision information including a revision number (new Rev.) in the displayed drawing attribute data Datt, and selects a “CREATE DRAWING REGISTRATION REQUEST SLIP” button in the revision registration image 88, whereupon the drawing attribute data registration image 84 shown in FIG. 8 which reflects the drawing attribute data Datt entered in the revision registration image 88 is displayed. The operator then enters any further necessary drawing attribute data Datt in the displayed drawing attribute data registration image 84.

If the revision registration process using the revision registration image 88 is performed, the drawing attribute data registering means 60 stores the information of the old drawing 30 prior to being revised in the drawing history master table MT3.

After the operator has set the drawing attribute data Datt as described above, the operator selects a “SEND TO REGISTRATION POST” in the drawing attribute data registration image 84 to sent the drawing reservation data to the drawing information editing device 14.

When the operator selects a “PRINT” button in the drawing attribute data registration image 84, the registration request slip output means 64 outputs the registration request slip 62 shown in FIG. 12 from the output device 24B in step S4.

The operator signs an “IN CHARGE” column in the registration request slip 62, and submits the registration request slip 62 as attached to the drawing 30 to be registered to an approval person. The approval person confirms the contents of the drawing 30, and signs an “APPROVED” column in the registration request slip 62 in step S5.

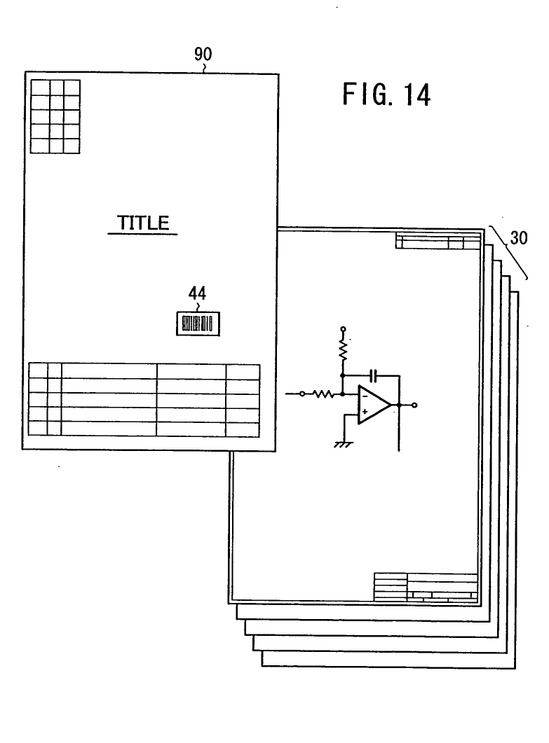

The drawing 30 that has been approved is transferred to a drawing registrar for registration. Prior to the registration of the drawing 30, the bar-code-output means 46 of the drawing information editing device 14 outputs a bar code 44 that is combined with ID number set as the drawing attribute data Datt of the drawing 30 from the output device 24A in step S6. The operator applies the bar code 44 to a given position on the drawing 30 in the form of single sheet in step S7. If the drawing 30 is in the form of a bundle of sheets such as circuit drawing sheets or document sheets, then as shown in FIG. 14, a cover sheet 90 indicating a given title is added to the bundle of sheets of the drawing 30, and the bar code 44 is applied to the cover sheet 90.

Then, the drawing registrar compares the registration request slip 62 (see FIG. 12) attached to the drawing 30 and the drawing attribute data Datt stored as the drawing reservation data in the registration post with each other for confirmation, and starts the process of registering the drawing 30 with the drawing registering device 12.

The drawing reading condition setting means 38 of the drawing information editing device 14 displays an image for setting drawing reading conditions such as a resolution, a reading size, a reading direction, etc. of the drawing 30 on the display monitor. The drawing registrar then sets drawing reading conditions depending on the drawing 30 to be registered according to the displayed setting image in step S8.

When the drawing reading conditions are set, the drawing input/output means 36 of the drawing information editing device 14 controls the drawing registering device 12 according to the drawing reading conditions to read the drawing 30 with the scanner 28 in step S9.

The drawing 30 as read by the scanner 28 is registered as actual drawing image data Dorg, which is uncompressed image data, together with related drawing attribute data Datt, in the data storage device 32 in step S10.

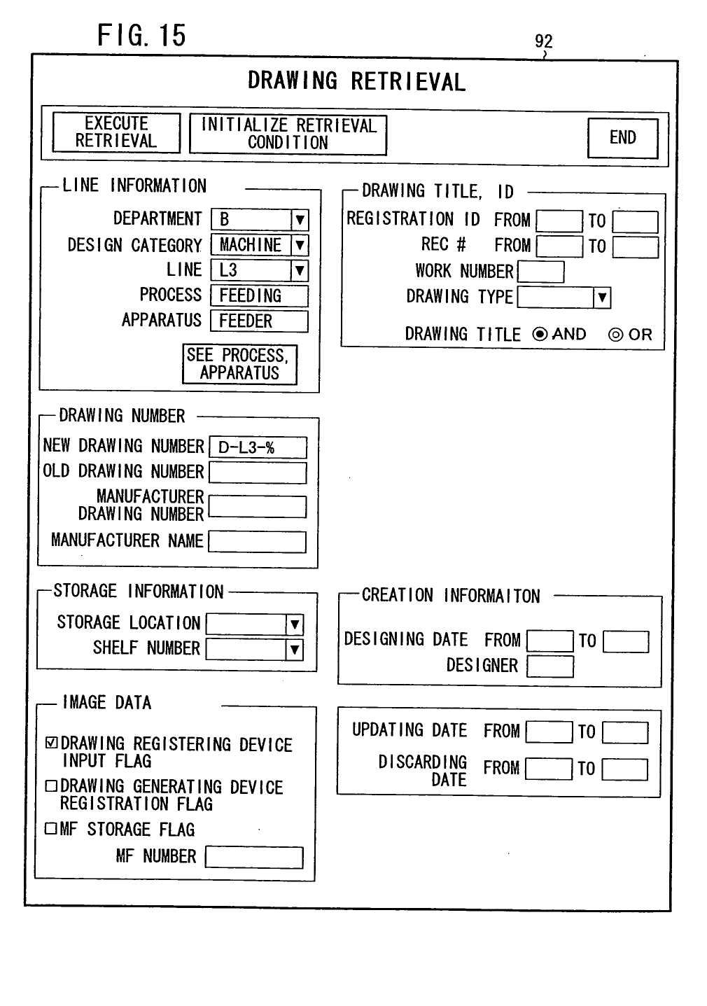

When the actual drawing image data Dorg is registered in the data storage device 32, the drawing information editing device 14 sets a drawing registering device input flag (see FIG. 15) which indicates that the drawing 30 is entered into the data storage device 32, with respect to the drawing attribute data Datt. After having registered the drawing 30, the drawing registrar signs a “REGISTRATION” column in the registration request slip 62 (see FIG. 12), and returns the registration request slip 62 together with the drawing 30 to the person who has requested the drawing registration.

After the actual drawing image data Dorg is registered in the data storage device 32, the drawing compressing means 40 of the drawing information editing device 14 compresses, e.g., image-codes, the actual drawing image data Dorg in step S11, generating compressed drawing image data Dcom. Then, the drawing input/output means 36 sends the actual drawing image data Dorg and the compressed drawing image data Dcom via the network 26 to the drawing information storing device 16, which registers them in the data storage device 34 in step S12.

If the drawing saving device 18 confirms that the actual drawing image data Dorg is registered in the data storage device 32 based on the drawing registering device input flag of the drawing attribute data Datt, then the drawing saving device 18 determines whether the drawing 30 has been saved on the microfilm 50 or not based on MF storage flag of the drawing attribute data Datt (see FIG. 15) in step S13.

If there is a drawing 30 which has not been saved on the microfilm 50, then the drawing retrieving means 52 of the drawing saving device 18 reads actual drawing image data Dorg of the drawing 30 from the data storage device 32 in step S14, and the drawing output means 54 outputs the drawing 30 relative to the drawing attribute data Datt through a CD-ROM or the like to the microfilm 50, thus saving the drawing 30 on the microfilm 50 in step S15. The attribute data editing means 56 sets an MF storage flag of the drawing attribute data Datt, sets a number of the microfilm 50 (MF-number), and rewrites the drawing attribute data Datt in the data storage device 32 and the data storage device 34.

Since the drawings 30 are registered on the microfilm 50, even if the data of the drawings 30 that are registered in the data storage device 32 and the data storage device 34 are destroyed, the data of the drawings 30 can be recovered from the microfilm 50. Therefore, when a drawing 30 is confirmed as being saved on the microfilm 50, the drawing 30 in the form of a paper sheet or sheets can be discarded, and its storage space is no longer necessary.

A process of retrieving a drawing 30 thus registered will be described below with reference to FIG. 4.

If the operator selects a “DRAWING RETRIEVAL” button in the menu image 80 (see FIG. 5) displayed on the display monitor of the drawing retrieving device 20, a retrieval condition input image 92 shown in FIG. 15 is displayed on the display monitor. The operator then enters a retrieval condition for a desired drawing 30 in the retrieval condition input image 92 in step S21. The retrieval condition may be drawing attribute data Datt of the drawing 30 stored in the data storage device 34.

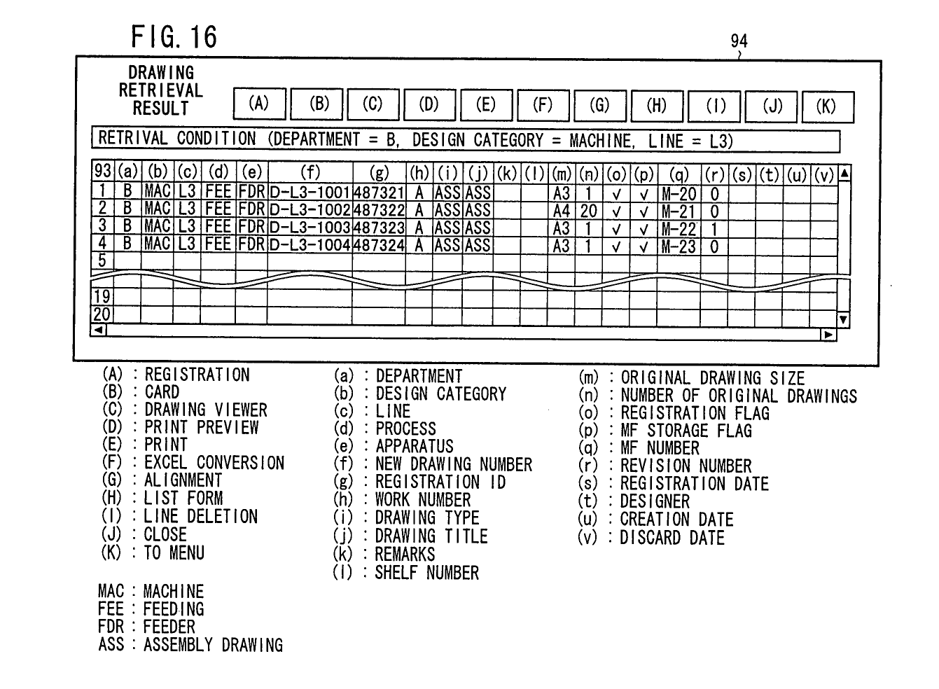

When the retrieval condition is entered and a “EXECUTE RETRIEVAL” button is selected, the drawing retrieving means 66 retrieves drawing attribute data Datt corresponding to the retrieval condition in step S22, and displays a drawing retrieval result image 94 shown in FIG. 16 in step S23. The drawing retrieval result image 94 displays only the retrieved drawing attribute data Datt of the drawing 30.

The operator designates desired drawing data from the drawing attribute data Datt displayed in the drawing retrieval result image 94 in step S24. If the operator finds it difficult to narrow the desired drawing data to one with the drawing attribute data Datt only, then the operator designates a plurality of drawing data.

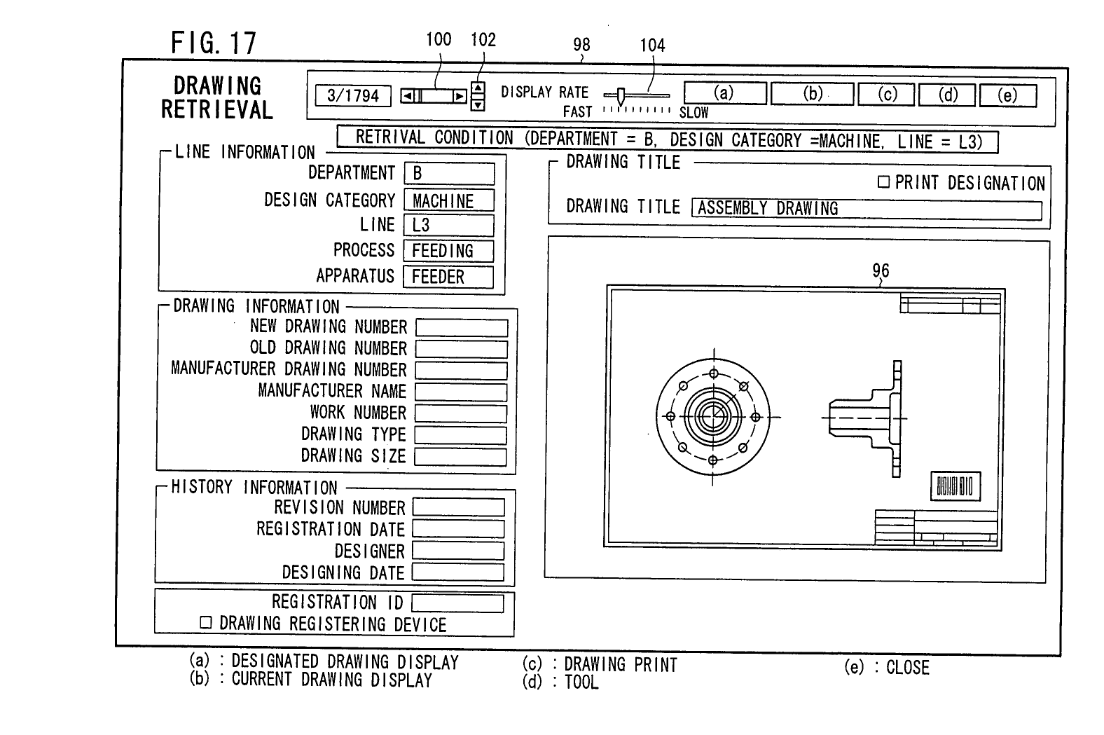

When the operator designates desired drawing data and selects a “DRAWING VIEWER” button, the retrieved drawing displaying means 68 requests the drawing information storing device 16 to send compressed drawing image data Dcom relative to the designated drawing data in step S25. The drawing information storing device 16 reads the requested compressed drawing image data Dcom from the data storage device 34, and sends the compressed drawing image data Dcom to the drawing retrieving device 20. As shown in FIG. 17, the drawing retrieving device 20 displays a compressed drawing 96 according to the compressed drawing image data Dcom, together with its drawing attribute data Datt, as a drawing retrieval result image 98 in step S26.

Since the compressed drawing 96 displayed in the drawing retrieval result image 98 is based on the compressed drawing image data Dcom transmitted from the data storage device 34 which is much smaller in amount than the actual drawing image data Dorg, the compressed drawing 96 can be displayed in a very short period of time. Since the drawing retrieval result image 98 includes the drawing title as the drawing attribute data Datt, the operator can grasp the drawing contents from the displayed drawing title even if the details of the displayed compressed drawing 96 cannot be determined.

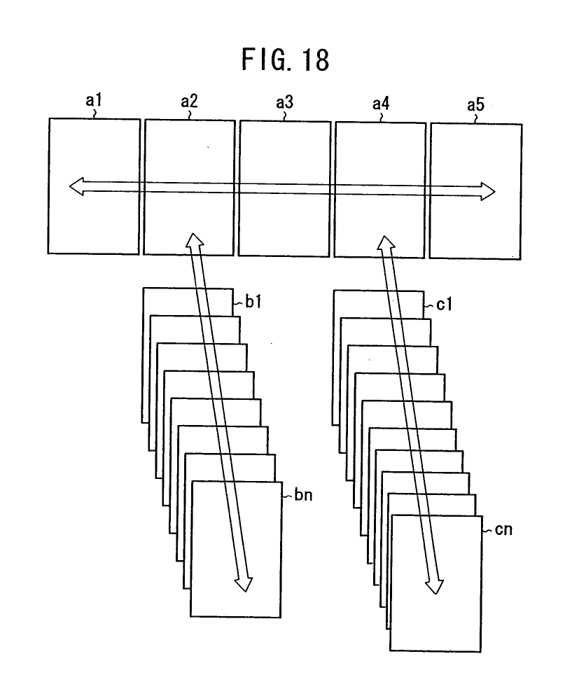

The drawing retrieval result image 98 also includes a horizontal scroll bar 100 and a vertical scroll bar 102. If a plurality of drawing data are selected in the drawing retrieval result image 94 shown in FIG. 16, then the operator operates the horizontal scroll bar 100 to scroll through and display the drawing attribute data Datt and the compressed drawings 96 relative to the drawing data, successively in the order of drawing data designed in the drawing retrieval result image 94, e.g., in the order of compressed drawings a1, a2, . . . , a5 as shown in FIG. 18, in step S27. The compressed drawings 96 can quickly be displayed because the amount of data of each of the compressed drawings 96 is small.

The operator can successively scroll through the compressed drawings 96 by continuously pressing the horizontal scroll bar 100. The scrolling rate can be adjusted as desired by operating a rate setting bar 104.

The vertical scroll bar 102 is used to scroll through the drawing 30 if the drawing 30 is in the form of a bundle of sheets such as circuit drawing sheets or document sheets, as shown in FIG. 14. Specifically, if two or more data are set as the data of the number of original drawing sheets in the drawing retrieval result image 94 shown in FIG. 16, then the drawing retrieval result image 98 displays the cover sheet 90 as the compressed drawing 96. If the compressed drawing 96 is the compressed drawing a2 or a4 shown in FIG. 18, then when the vertical scroll bar 102 is displayed while it is being displayed, the drawing attribute data Datt except for the drawing title is displayed in a fixed manner, but the drawing title and the compressed drawing 96 are displayed successively in the order of compressed drawings b1, b2, . . . , bn, or compressed drawings c1, c2, . . . , cn in step S27.

When the rate setting bar 104 is operated at this time, the scrolling rate for the vertical scroll bar 102 can also be adjusted.

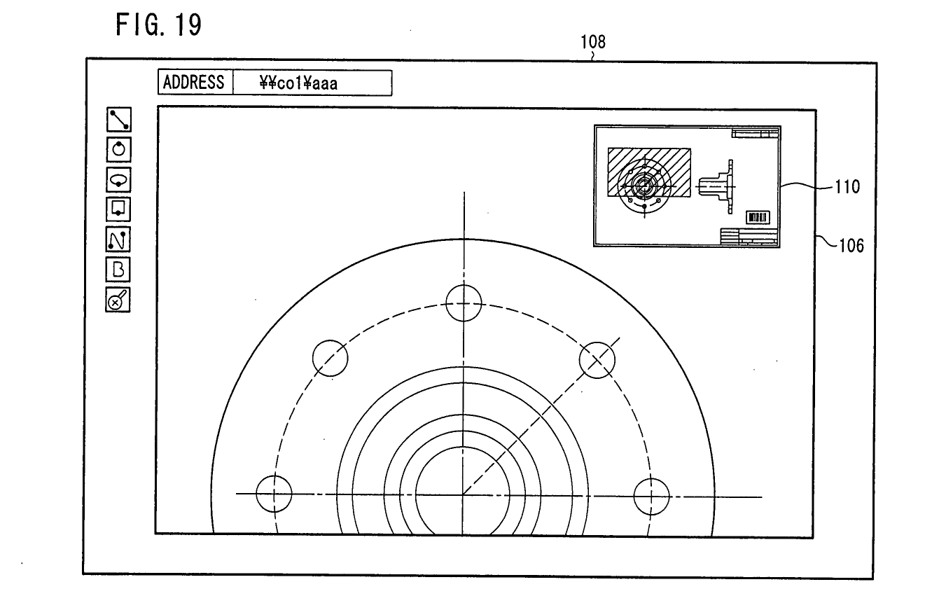

After the desired drawing 30 is retrieved from the successively displayed compressed drawings 96, the operator selects a “CURRENT DRAWING DISPLAY” button in the drawing retrieval result image 98 in step S28. The selected drawing displaying means 70 requests the drawing information storing device 16 to send actual drawing image data Dorg relative to the displayed drawing data in step S29. The drawing information storing device 16 reads the requested actual drawing image data Dorg from the data storage device 34, and sends the actual drawing image data Dorg to the drawing retrieving device 20. As shown in FIG. 19, the drawing retrieving device 20 displays an uncompressed actual drawing 106 according to the actual drawing image data Dorg as a drawing retrieval result image 108 in step S30.

Since the actual drawing 106 displayed in the drawing retrieval result image 108 is based on the uncompressed actual drawing image data Dorg that is transferred from the data storage device 34, it takes a longer period of time to display the actual drawing 106 than the compressed drawing 96. However, as the actual drawing 106 is only one, the display time does not pose a significant problem. A total display compressed drawing 110 in which a displayed area of the actual drawing 106 is shown hatched is also displayed together with the actual drawing 106. The total display compressed drawing 110 allows the operator to easily confirm the position of the displayed area of the actual drawing 106 even if the actual drawing 106 cannot be displayed in its entirety at once on the display monitor.

The operator confirms the displayed actual drawing 106. If the displayed actual drawing 106 is the desired drawing 30, then the operator selects a printing process to output the drawing 30 from the output device 24B in step S31.

A process of retrieving a completion report will be described below. The completion report represents a file of a series of drawings 30 including a design drawing, an inspection document, a calculation document, an estimation document, etc. about a facility construction, for example.

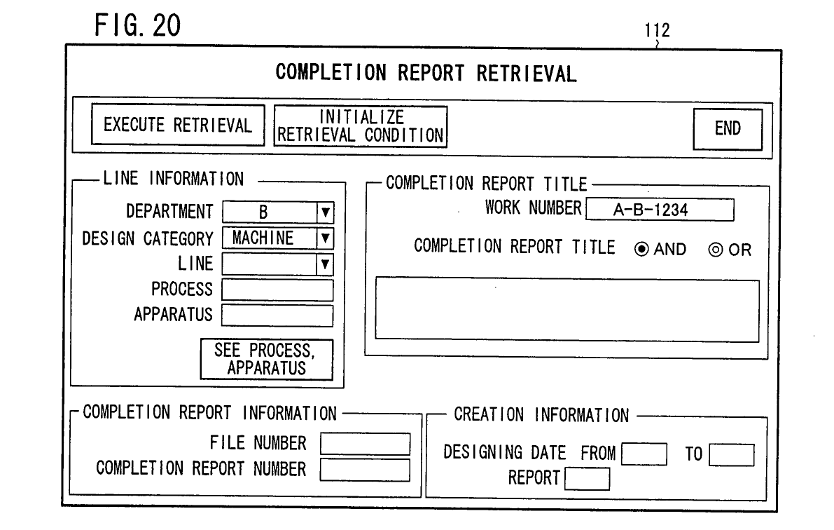

When the operator selects a “RETRIEVAL” button in the menu image 80 shown in FIG. 5, a retrieval condition input image 112 shown in FIG. 20 is displayed on the display monitor. The operator retrieves a desired construction using the retrieval condition input image 112. For example, when a drawing 30 is registered, a work number (see FIG. 9) and a work title are set as drawing attribute data Datt. In this manner, drawing attribute data Datt having the same work number can be retrieved as being related to the same work.

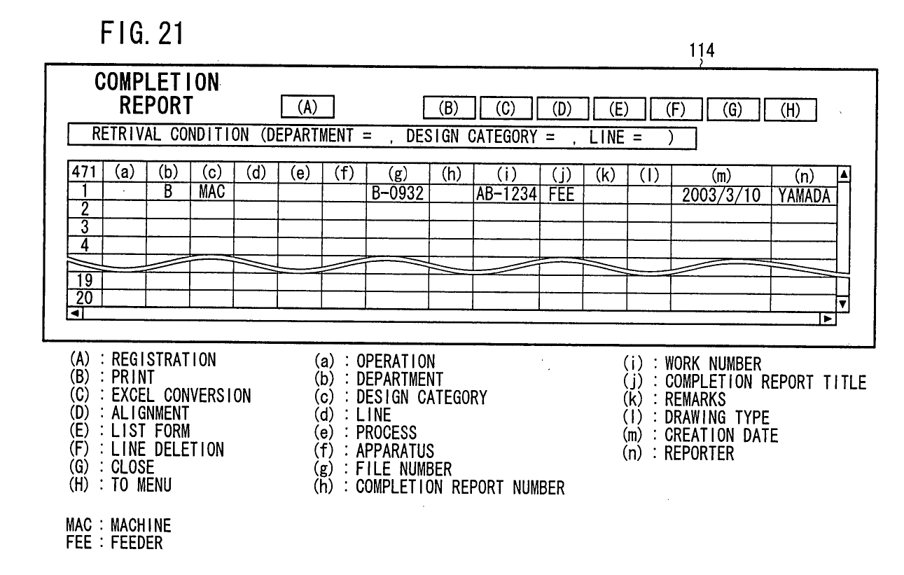

The completion report retrieving means 74 retrieves a completion report having a corresponding work number, using the drawing attribute data Datt entered in the retrieval condition input image 112 as a retrieval condition, and displays a completion report list image 114 shown in FIG. 21. The operator selects a desired completion report based on a completion report title which is a work title displayed in the completion report list image 114, so that the operator can extract a related drawing 30. If necessary, all drawings 30 that make up the completion report can be output from the output device 24B.

Although a certain preferred embodiment of the present invention has been shown and described in detail, it should be understood that various changes and modifications may be made therein without departing from the scope of the appended claims.

1. A drawing management system comprising:
a drawing registering device for registering a drawing as image data;
a drawing information editing device for editing drawing attribute data relative to said drawing and said image data;
a drawing information storing device for storing said drawing attribute data and said image data; and
a drawing retrieving device for retrieving said drawing attribute data based on an entered retrieval condition, and outputting the retrieved drawing attribute data and said drawing based on said image data relative to said drawing attribute data.

2. A drawing management system according to claim 1, wherein said drawing retrieving device has drawing reserving means for setting drawing reservation data before said drawing is registered by said drawing registering device, and said drawing information editing device edits said drawing attribute data and said drawing based on said drawing reservation data.

3. A drawing management system according to claim 1, wherein said drawing information editing device edits said drawing attribute data according to a pre-registered general code master table.

4. A drawing management system according to claim 1, wherein said drawing information editing device edits said drawing attribute data relative to a revision of said drawing as a drawing history master table.

5. A drawing management system according to claim 2, wherein said drawing retrieving device has registration request slip output means for generating a registration request slip based on said drawing reservation data before said drawing is registered by said drawing registering device, and said drawing information editing device edits said drawing attribute data and said drawing based on said registration request slip.

6. A drawing management system according to claim 1, wherein said drawing retrieving device has completion report retrieving means for retrieving a completion report having a series of said drawings related by said drawing attribute data.

7. A drawing management system according to claim 1, further comprising:
a drawing saving device for saving said drawing which is registered by said drawing registering device in an external storage medium.

8. A drawing management system according to claim 1, further comprising:
an output device for outputting a bar code set as said drawing attribute data, said bar code being to be applied to said drawing.

9. A drawing management system according to claim 7, wherein said external storage medium comprises a microfilm.

10. A drawing management system according to claim 1, wherein said drawing includes a document image.

11. A drawing management system according to claim 1, wherein said drawing information storing device stores compressed image data produced by compressing the image data of said drawing in association with said drawing attribute data, and said drawing retrieving device retrieves said compressed image data using said drawing attribute data as a retrieval condition and outputs a desired drawing based on said compressed image data.

12. A drawing management system according to claim 11, wherein said drawing information storing device stores said image data and said compressed image data in association with said drawing attribute data, and said drawing retrieving device retrieves said compressed image data based on said retrieval condition and comprises retrieved drawing displaying means for outputting a compressed drawing based on said compressed image data, and drawing output means for outputting a desired drawing based on said image data of a desired compressed drawing selected from said compressed drawing output by said retrieved drawing displaying means.

13. A drawing management system according to claim 12, wherein said retrieved drawing displaying means comprises a compressed drawing display section for displaying said compressed drawing, a drawing attribute data display section for displaying said drawing attribute data relative to said compressed drawing, and a display switching section for switching said compressed drawing and said drawing attribute data for display.

14. A drawing management system according to claim 13, wherein said drawing attribute data displayed by said compressed drawing display section includes a drawing title relative to said compressed drawing.

15. A drawing management system according to claim 13, wherein said display switching section is arranged to adjust a display switching rate for said compressed drawing and said drawing attribute data.

16. A drawing management system according to claim 1, wherein said drawing information storing device stores a single sheet in which said drawing attribute data and said image data are in one-to-one correspondence and a bundle of sheets in which said drawing attribute data and said image data are in one-to-many correspondence in accordance with the drawing attribute data, and said drawing retrieving device comprises a drawing display section for retrieving said image data based on said retrieval condition and displaying said single sheet or one of said bundle of sheets based on said image data, a single sheet switching section for switching between single sheets for display, and a bundle-of-sheets switching section for switching between the sheets of said bundle for display.

17. A drawing management system according to claim 16, wherein single sheet switching section switches between single sheets including one of the sheets of said bundle for display.

18. A drawing management system according to claim 16, wherein said single sheet switching section or said bundle-of-sheets switching section is arranged to adjust a display switching rate for said single sheet or the sheets of said bundle for display.
